(19) United States
(12) Patent Application Publication
(10) Pub. No.: US 2003/0047146 A1
(43) Pub. Date: Mar. 13, 2003

(54) Plasmatron-internal combustion engine system having an independent electrical power source

(76) Inventors: Michael J. Daniel, Royal Oak, MI (US); Mehmet S. Ciray, Greenwood, IN (US); Kurt D. Zwanzig, Columbus, IN (US)

Correspondence Address: BARNES & THORNBURG, 11 SOUTH MERIDIAN, INDIANAPOLIS, IN, 46204

(21) Appl. No.: 09/949,963

(22) Filed: Sep. 10, 2001

(51) Int. Cl. F02B 43/08

(52) U.S. Cl. 123/3

(57) ABSTRACT

A rotary power system has a plasmatron and an internal combustion engine. The plasmatron reforms hydrocarbon fuels so as to produce a reformed gas which is supplied to the internal combustion engine. An electrical power source, which is independent of the mechanical output of the internal combustion engine, provides electrical power for operation of the plasmatron.

### FIELD OF THE DISCLOSURE

The present invention relates to generally to an internal combustion engine system, and more particularly to a plasmatron-internal combustion engine system having an independent electrical power source.

### BACKGROUND OF THE DISCLOSURE

Hydrogen has been used as a fuel or fuel additive for an internal combustion engine in an effort to reduce emissions from the engine. One manner of producing hydrogen for use with an internal combustion is by the operation of a plasmatron. A plasmatron reforms hydrocarbon fuel into a reformed gas such as hydrogen-rich gas. Specifically, a plasmatron heats an electrically conducting gas either by an arc discharge or by a high frequency inductive or microwave discharge. The internal combustion engine combusts the hydrogen-rich gas from the plasmatron either as the sole source of fuel, or in conjunction with hydrocarbon fuels. Systems including plasmatrons are disclosed in U.S. Pat. No. 5,425,332 issued to Rabinovich et al.; U.S. Pat. No. 5,437,250 issued to Rabinovich et al.; U.S. Pat. No. 5,409,784 issued to Brumberg et al.; and U.S. Pat. No. 5,887,554 issued to Cohn, et al.

### SUMMARY OF THE DISCLOSURE

According to one illustrative embodiment, there is provided a rotary power system having a plasmatron and an internal combustion engine. The plasmatron reforms hydrocarbon fuels so as to produce a reformed gas which is supplied to the internal combustion engine. An electrical power source, which is independent of the mechanical output of the internal combustion engine, provides electrical power for operation of the plasmatron.

According to a more specific illustrative embodiment, there is provided a rotary power system having a plasmatron configured to reform hydrocarbon fuel into a reformed gas, and an internal combustion engine configured to receive the reformed gas from the plasmatron and produce mechanical output. A transmission is mechanically coupled to the internal combustion engine so as to be driven by the mechanical output, whereas an electrical power source is electrically coupled to the plasmatron so as to provide electrical energy to operate the plasmatron. The electrical power source operates independently of the mechanical output of the internal combustion engine.

In accordance with another more specific illustrative embodiment, there is provided rotary power system having a plasmatron configured to reform hydrocarbon fuel into a reformed gas, and an internal combustion engine configured to receive the reformed gas from the plasmatron and produce mechanical output. An electric generator is mechanically coupled to the internal combustion engine so as to be driven by the mechanical output, whereas an electrical power source is electrically coupled to the plasmatron so as to provide electrical energy to operate the plasmatron. The electrical power source operates independently of the mechanical output of the internal combustion engine.

According to a more specific illustrative embodiment, there is provided a rotary power system. The rotary power system includes a plasmatron which is configured to reform hydrocarbon fuel into a reformed gas, and an internal combustion engine which is configured to receive the reformed gas from the plasmatron and produce mechanical output. The rotary power system also includes a fuel cell which is electively coupled to the plasmatron so as to provide electrical energy to operate the plasmatron.

In accordance with yet another illustrative embodiment of the present invention, there is provided a hydrocarbon fuel reforming system for use with an internal combustion engine and a fuel cell. The system includes a plasmatron having (i) an electrical power input which is adapted to be electrically coupled to the fuel cell, and (ii) a reformed gas outlet adapted to be fluidly coupled to a fuel inlet of the internal combustion engine. The plasmatron is powered by electrical energy from the fuel cell when the electrical power input is electrically coupled to the fuel cell. The plasmatron supplies reformed gas to the internal combustion engine when the reformed gas outlet is fluidly coupled to the fluid inlet.

In accordance with a further illustrative embodiment of the present invention, there is provided a rotary power system. The rotary power system includes an internal combustion engine and a fuel cell. The system also includes a plasmatron which is configured to reform hydrocarbon fuel into reformed gas. The plasmatron is fluidly coupled to both the internal combustion engine and the fuel cell so as to supply the reformed gas to both the internal combustion engine and the fuel cell.

### BRIEF DESCRIPTION OF THE DRAWINGS

FIG. 1 is a simplified block diagram of a rotary power system;

FIG. 2 is a simplified block diagram of a second embodiment of a rotary power system;

FIG. 3 is a simplified block diagram of a third embodiment of a rotary power system;

FIG. 4 is a simplified block diagram of a fourth embodiment of a rotary power system; and

FIG. 5 is a simplified block diagram of a fifth embodiment of a rotary power system.

### DETAILED DESCRIPTION OF ILLUSTRATIVE EMBODIMENTS

While the invention is susceptible to various modifications and alternative forms, specific exemplary embodiments thereof have been shown by way of example in the drawings and will herein be described in detail. It should be understood, however, that there is no intent to limit the invention to the particular forms disclosed, but on the contrary, the intention is to cover all modifications, equivalents, and alternatives following within the spirit and scope of the invention as defined by the appended claims.

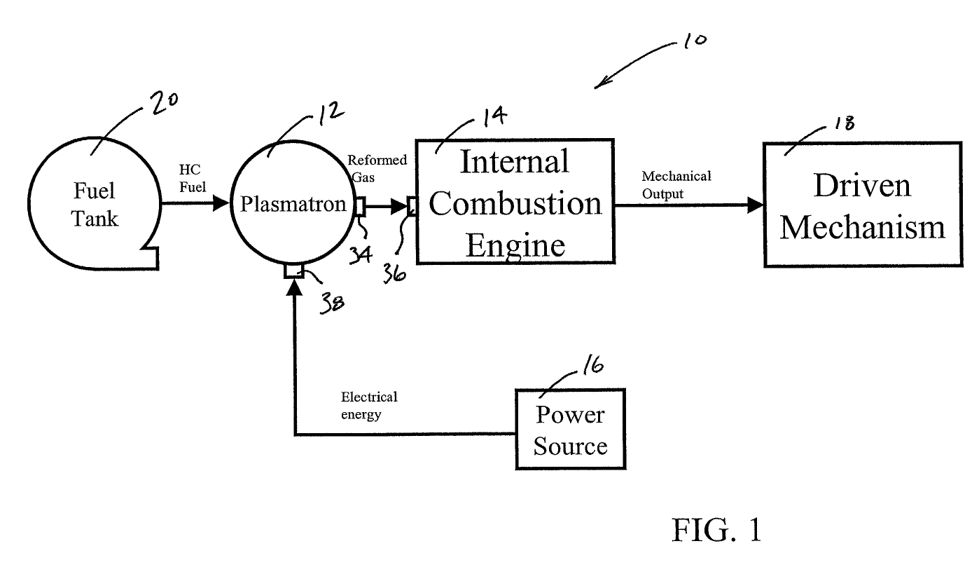

Referring now to FIGS. 1-5, there is shown a rotary system 10 which includes a plasmatron 12, an internal combustion engine 14, and a power source 16. The plasmatron 12 is a fuel reformer which uses a plasma—an electrically heated gas—to convert hydrocarbon fuel from a fuel tank 20 into a reformed gas such as a hydrogen-rich gas. A plasmatron which is suited for use as the plasmatron 12 of the rotary power system 10 is any one of the plasmatrons disclosed in U.S. Pat. No. 5,409,784 issued to Brumberg et al.; U.S. Pat. No. 5,425,332 issued to Rabinovich et al.; U.S. Pat. No. 5,437,250 issued to Rabinovich et al.; and U.S. Pat. No. 5,887,554 issued to Cohn et al., the disclosures of each of which is hereby incorporated by reference.

Hydrogen-rich gas generated by the plasmatron 12 is supplied to the internal combustion engine 14. Specifically, as shown in FIGS. 1-5, the plasmatron 12 has a reformed gas outlet 34 which is fluidly coupled to a fuel inlet 36 of the internal combustion engine such that the reformed gas produced by the plasmatron 12 (e.g., hydrogen-rich gas) may be advanced from the plasmatron 12 to the combustion chambers of the internal combustion engine 14. It should be appreciated that the fuel inlet 36 of the internal combustion engine 14 may be embodied as a carburetor for advancing fuel into the engine's combustion chambers, a fuel injection assembly for injecting fuel into the engine's combustion chambers, or any other similar device, depending on the particular design of the engine. The internal combustion engine 14 combusts the reformed gas as either the sole source of fuel, or alternatively, as a fuel additive to a hydrocarbon fuel.

Operation of the internal combustion engine produces mechanical output which is utilized to drive or otherwise mechanically power a driven mechanism 18. Specifically, the driven mechanism 18 is mechanically coupled to an output mechanism of the internal combustion engine 14 such as a crankshaft or the like. The driven mechanism 18 may be embodied as a transmission, specifically a vehicle transmission, which is utilized to propel a vehicle. In the case of when the rotary power system 10 is utilized in the construction of a stationary power-generating system or a hybrid vehicle, the driven mechanism 18 may be provided as a power generator or the like for producing electrical power from the mechanical output of the internal combustion engine 14. The driven mechanism 18 may be embodied as any type of mechanism which is driven by an internal combustion engine. For example, the drive mechanism 18 may be embodied as a pump mechanism or the like.

The power source 16 is electrically coupled to an electrical power input 38 of the plasmatron 12. The power input 38 may be embodied as a pair of electrodes or other type or terminals, or as an input of a power supply (not shown) which may be utilized to regulate the power being supplied to the plasmatron 12.

The power source 16 is operates independently of the mechanical output of the internal combustion engine 14. What is meant herein by the terms “independent” or “independently” in reference to the operation of the power source 16 relative to the internal combustion engine 14 is that the mechanical output from the internal combustion engine is not used by the power source 16 for the production of electrical energy. For example, as will hereinafter described in greater detail, the power source 16 may be embodied as a system having one or more fuel cells. A fuel cell operates “independently” of the internal combustion engine 14 since mechanical output from the internal combustion engine 14, or from any other device for that matter, is not needed to operate a fuel cell. Conversely, a system which utilizes a generator, such as an alternator which is driven by the mechanical output of the internal combustion engine 14, would not be an “independent” power source. Indeed, a generator (e.g., an alternator) utilizes mechanical energy from the internal combustion engine (via a belt and pulley system) to produce electrical energy.

It should be appreciated that certain power sources may also have batteries associated therewith. For example, an generator/alternator-based system would likely include a battery for storing electrical energy generated by the generator/alternator. However, such a battery would still not be an “independent” power source since the electrical energy stored in the battery is generated by a mechanism (i.e., the generator/alternator) which is dependent on mechanical output from the internal combustion engine 14. Conversely, a battery associated with a fuel cell would be an “independent” power source since the electrical energy stored therein is not generated by use of mechanical output from the internal combustion engine.

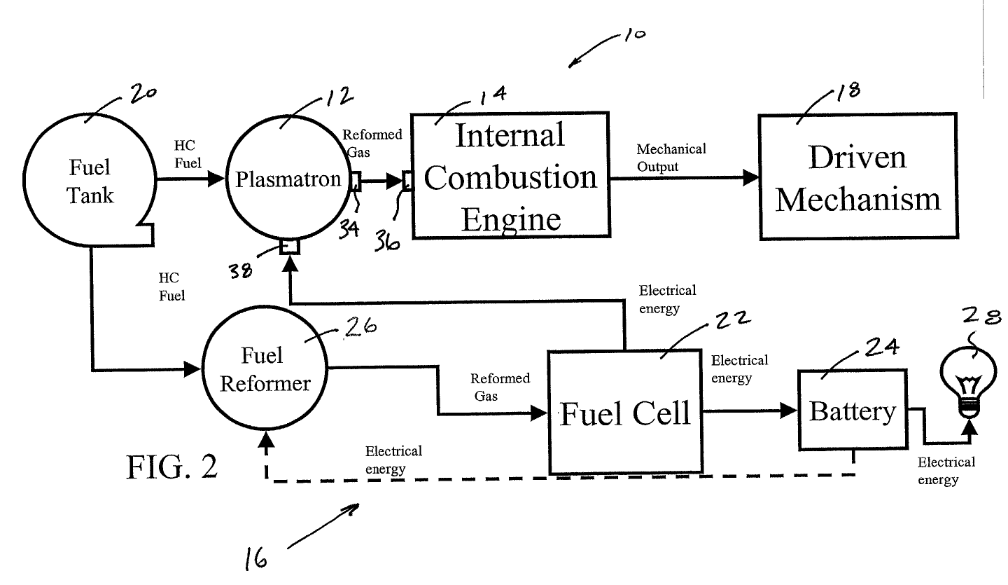

A more specific exemplary embodiment of a rotary power system having such an independent power source 16 is shown in FIG. 2 in which the power source 16 is provided as a fuel cell-based system. Specifically, the power source 16 includes a fuel cell 22, a battery 24, and a fuel reformer 26. Hydrocarbon fuel from the fuel tank 20 is reformed by the fuel reformer 26 into a reformed gas which is input into the fuel cell 22. The fuel cell 22 of the rotary system 10 may be provided as any type of fuel cell. For example, the fuel cell 22 may be embodied as an alkaline fuel cell (AFC), a phosphoric acid fuel cell (PAFC), a proton exchange membrane fuel cell (PEMFC), a solid oxide fuel cell (SOFC), a molten carbonate fuel cell (MCFC), or any other type of fuel cell.

The fuel cell 22 utilizes the reformed gas from the fuel reformer 26 to create electrical energy which is used in operation of the rotary power system 10. Specifically, a portion of the electrical energy generated by the fuel cell 22 is provided to the plasmatron 12 for operation thereof. In particular, the fuel cell 22 is electrically coupled to the power input 38 of the plasmatron 12 thereby providing the electrical energy necessary to operate the plasmatron 12. In addition, electrical energy generated by the fuel cell 22 is also stored in the battery 24 for use by other components. Specifically, electrical energy generated by the fuel cell 22 (and stored in the battery 24) may be utilized for operation of a number of electrical accessories 28. In the case of a vehicular application of the rotary power system 10, the accessories 28 may include the vehicles lights, electronics, or the like.

Moreover, electrical energy generated by the fuel cell 22 (and stored in the battery 24) may be utilized to operate the fuel reformer 26 if the fuel reformer 26 is of the type which requires electrical energy for the operation thereof. Specifically, the fuel reformer 26 may be embodied as any type of fuel reformer (e.g., plasma fuel reformer, thermal fuel reformer, steam fuel reformer, catalytic fuel reformer, etc.). To the extent that a given design of the fuel reformer 26 utilizes electrical energy, such electrical energy would be provided by the fuel cell 22/battery 24 arrangement.

It should appreciated that although shown in FIG. 2 as operating in conjunction with the battery 24, the fuel cell 22 may be operated without the use of such a battery. Specifically, the fuel cell 22 may be operated without the use of a battery 24 in which case the fuel cell 22 would provide electrical energy directly to the accessories 28 and the fuel reformer 26 in a manner similar to that in which the fuel cell provides electrical energy to the plasmatron 12.

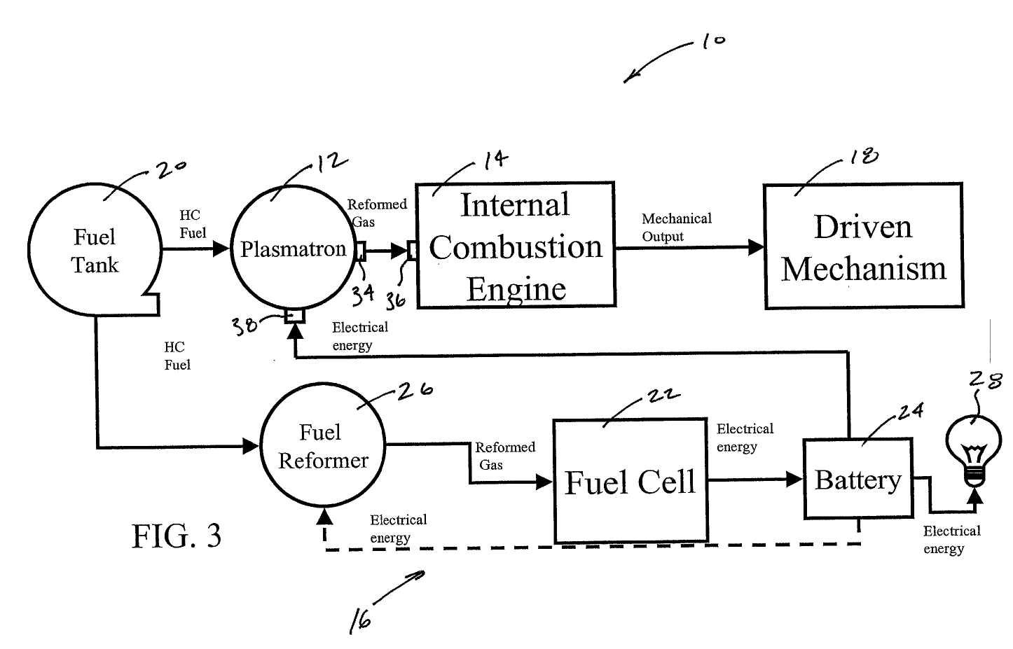

As shown in FIG. 3, the power source 16 may also be configured such that the electrical energy necessary for operation of plasmatron 12 is provided from the battery 24, in lieu of directly from the fuel cell 22. Such a configuration may be particularly useful in certain designs of vehicles or stationary power generation systems.

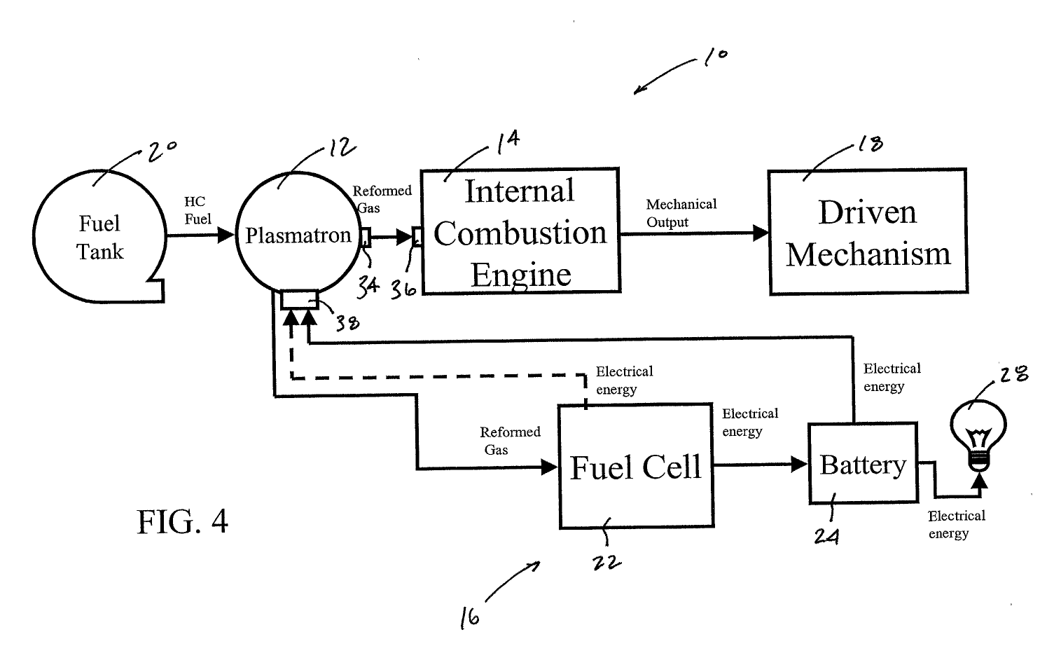

Referring now to FIG. 4, there is shown an embodiment of the rotary power system 10 in which the plasmatron 12 provides the reformed gas (e.g., hydrogen-rich gas) for operation of both the internal combustion engine 14 and the fuel cell 22. Specifically, in lieu of utilizing a separate fuel reformer for the operation of the fuel cell assembly (i.e., the fuel reformer 26 of FIGS. 2 and 3), reformed gas from the plasmatron 12 is supplied to both the internal combustion engine 14 and the fuel cell 22. As shown in FIG. 4, electrical energy may be supplied to the plasmatron 12 either directly from the fuel cell 22 or from the battery 24. The configuration of the rotary power system of FIG. 4 allows for component reduction and, as a result, the cost benefits associated therewith.

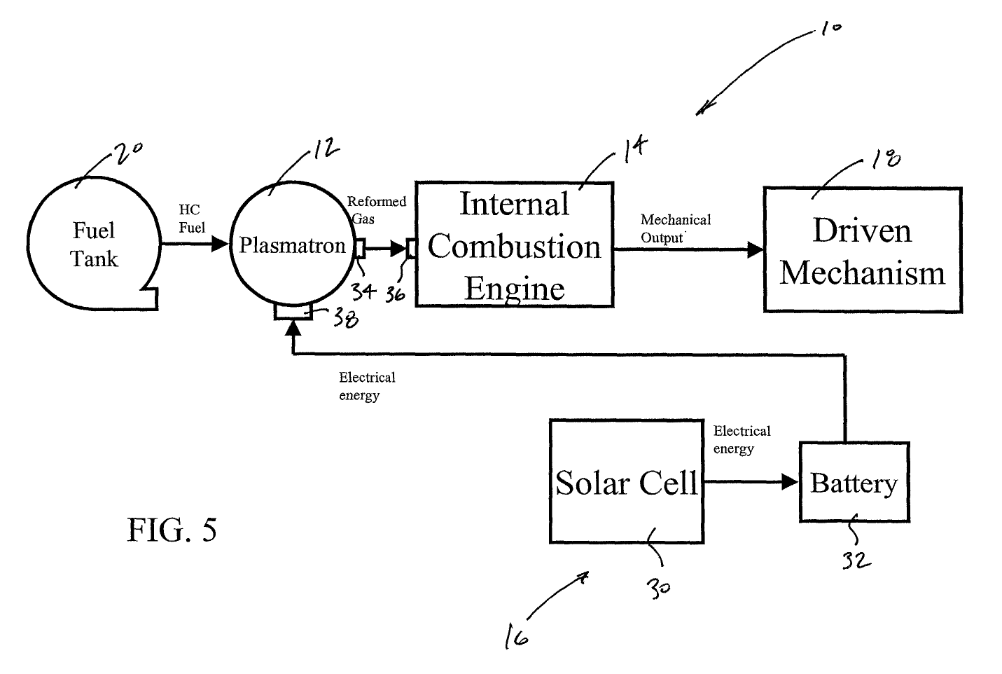

As shown in FIG. 5, additional types of power sources 16 are also contemplated for use in the rotary power system 10. For example, the power source 16 may be embodied as a system having a solar cell 30 for converting solar energy into electrical energy. In such a case, electrical energy produced by the solar cell 30 is utilized to operate the plasmatron 12. In particular, the solar cell 30 is electrically coupled to the power input 38 of the plasmatron so as to provide electrical energy thereto. It should be appreciated that a battery 32 may also be utilized in conjunction with the solar cell 30 to store electrical energy produced by the solar cell 30.

The solar cell based system of FIG. 5 is particularly useful for operation of the plasmatron 12 during initial operation of the internal combustion engine 14. In particular, electrical energy produced by the solar cell 30 (and stored in the battery 32) may be utilized to commence operation of the plasmatron 12 during the initial startup of the internal combustion engine 14. In such an arrangement, it may be advantageous to utilize the solar cell 30 as an auxiliary source of electrical energy with the primary source of electrical energy being provided by a different power source such as a fuel cell-based system similar to as described above. In such a manner, the electrical energy generated by the solar cell 30 (and stored in the battery 32) is utilized to provide energy to the plasmatron 12 during initial startup of the internal combustion engine 14, whereas the electrical requirements of the plasmatron 12 during extended use of the internal combustion engine 14 is provided by the primary power source (e.g., the fuel cell).

Moreover, other types of independent power sources 16 may also be utilized in lieu of the fuel cell 22 or the solar cell 30. For example, a number of thermoelectric modules which convert thermal energy (i.e., heat) into electricity. Such thermoelectric modules may be configured to utilize thermal energy in the exhaust gases produced by the internal combustion engine 14 to produce electrical energy. Alternatively, in the case of a vehicular application, a thermoelectric module may be configured to utilize heat from the vehicle's brake system to generate electrical energy. In either case, it should be appreciated that such a thermoelectric module may be utilized along with a battery for storing electrical energy produced by the module.

As can be seen from the foregoing description, the concepts of the present invention provides numerous advantages and benefits relative to other systems. For example, amongst other things, the concepts of the present invention allow for the powering of the plasmatron 12 without the use of mechanical output from the internal combustion engine therefor. As a result, the mechanical output from the internal combustion engine

While the invention has been illustrated and described in detail in the drawings and foregoing description, such an illustration and description is to be considered as exemplary and not restrictive in character, it being understood that only the illustrative embodiments have been shown and described and that all changes and modifications that come within the spirit of the invention are desired to be protected.

There are a plurality of advantages of the present invention arising from the various features of the system described herein. It will be noted that alternative embodiments of each of the system of the present invention may not include all of the features described yet still benefit from at least some of the advantages of such features. Those of ordinary skill in the art may readily devise their own implementations of a system that incorporate one or more of the features of the present invention and fall within the spirit and scope of the present invention as defined by the appended claims.

For example, the fuel cell 22 described herein may be embodied a fuel cell which converts hydrocarbon fuels directly into electrical energy without the use of a fuel reformer (e.g., the fuel reformer 26 of FIGS. 2 and 3, and the plasmatron 12 of FIG. 4). In such a case, hydrocarbon fuel from the fuel tank 20 would be supplied directly to the fuel cell 22.

What is claimed is:

1. A rotary power system, comprising:
a plasmatron configured to reform hydrocarbon fuel into a reformed gas;
an internal combustion engine configured to (i) receive said reformed gas from said plasmatron; and (ii) produce mechanical output;
a transmission mechanically coupled to said internal combustion engine so as to be driven by said mechanical output; and
an electrical power source electrically coupled to said plasmatron so as to provide electrical energy to operate said plasmatron, wherein said electrical power source operates independently of said mechanical output of said internal combustion engine.

2. The system of claim 1, wherein said reformed gas includes a hydrogen-rich gas.

3. The system of claim 1, wherein said electrical power source includes a fuel cell.

4. The system of claim 1, wherein said electrical power source includes (i) a fuel cell, and (ii) a battery electrically coupled to both said fuel cell and said plasmatron.

5. The system of claim 1, wherein said electrical power source includes a solar cell.

6. The system of claim 1, wherein said electrical power source includes (i) a solar cell, and (ii) a battery electrically coupled to both said solar cell and said plasmatron.

7. The system of claim 1, wherein said electrical power source includes a thermoelectric module.

8. The system of claim 1, wherein said electrical power source includes (i) a thermoelectric module, and (ii) a battery electrically coupled to both said thermoelectric module and said plasmatron.

9. A rotary power system, comprising:
a plasmatron configured to reform hydrocarbon fuel into a reformed gas;
an internal combustion engine configured to (i) receive said reformed gas from said plasmatron; and (ii) produce mechanical output;
an electric generator mechanically coupled to said internal combustion engine so as to be driven by said mechanical output; and
an electrical power source electrically coupled to said plasmatron so as to provide electrical energy to operate said plasmatron, wherein said electrical power source operates independently of said mechanical output of said internal combustion engine.

10. The system of claim 9, wherein said reformed gas includes a hydrogen-rich gas.

11. The system of claim 9, wherein said electrical power source includes a fuel cell.

12. The system of claim 9, wherein said electrical power source includes (i) a fuel cell, and (ii) a battery electrically coupled to both said fuel cell and said plasmatron.

13. The system of claim 9, wherein said electrical power source includes a solar cell.

14. The system of claim 9, wherein said electrical power source includes (i) a solar cell, and (ii) a battery electrically coupled to both said solar cell and said plasmatron.

15. The system of claim 9, wherein said electrical power source includes a thermoelectric module.

16. The system of claim 9, wherein said electrical power source includes (i) a thermoelectric module, and (ii) a battery electrically coupled to both said thermoelectric module and said plasmatron.

17. A rotary power system, comprising:
a plasmatron configured to reform hydrocarbon fuel into a reformed gas;
an internal combustion engine configured to (i) receive said reformed gas from said plasmatron; and (ii) produce mechanical output; and
a fuel cell electrically coupled to said plasmatron so as to provide electrical energy to operate said plasmatron.

18. The system of claim 17, wherein said reformed gas includes a hydrogen-rich gas.

19. The system of claim 17, further comprising a battery, wherein said battery is electrically coupled to both said fuel cell and said plasmatron.

20. A hydrocarbon fuel reforming system for use with an internal combustion engine and a fuel cell, comprising:
a plasmatron having (i) an electrical input which is adapted to be electrically coupled to said fuel cell, and (ii) a reformed gas outlet adapted to be fluidly coupled to a fuel inlet of said internal combustion engine,
wherein said plasmatron (i) is powered by electrical energy from said fuel cell when said electrical input is electrically coupled to said fuel cell, and (ii) supplies reformed gas to said internal combustion engine when said reformed gas outlet is fluidly coupled to said fuel inlet.

21. The system of claim 20, wherein said reformed gas includes a hydrogen-rich gas.

22. A rotary power system, comprising:
an internal combustion engine;
a fuel cell; and
a plasmatron configured to reform hydrocarbon fuel into a reformed gas, said plasmatron being fluidly coupled to both said internal combustion engine and said fuel cell so as to supply said reformed gas to both said internal combustion engine and said fuel cell.

23. The system of claim 22, wherein said reformed gas includes a hydrogen-rich gas.

24. The system of claim 22, further comprising a battery, wherein said battery is electrically coupled to both said fuel cell and said plasmatron.
